(19) United States
(12) Patent Application Publication
(10) Pub. No.: US 2026/0283202 A1
(43) Pub. Date: Sep. 24, 2026

(54) Pulled Oxtail Meat and Methods of Preparation

(71) Applicants: Jocelyne Williams, Miami, FL (US); Keith Valles, Miami, FL (US)

(72) Inventors: Jocelyne Williams, Miami, FL (US); Keith Valles, Miami, FL (US)

(21) Appl. No.: 19/359,394

(22) Filed: Oct. 15, 2025

Related U.S. Application Data
(60) Provisional application No. 63/776,322, filed on Mar. 24, 2025.

(51) Int. Cl. A23L 13/20; A23L 13/72; A23L 27/12; A23L 27/40

(52) U.S. Cl. CPC A23L 13/20; A23L 13/72; A23L 27/12; A23L 27/40

(57) ABSTRACT

Provided herein are methods of preparing pulled oxtail meat products that are suitable for packaging and distribution.

### CROSS-REFERENCE TO RELATED APPLICATION

This application claims the benefit of priority to U.S. Provisional Patent Application Ser. No. 63/776,322 entitled “ORIGINAL PULLED OXTAIL MEAT,” filed Mar. 24, 2025, the disclosure of which is incorporated herein by reference in its entirety.

### BACKGROUND

Historically, oxtail has only been served and sold bone-in, limiting its convenience, accessibility, and culinary versatility. There is therefore a need for new ways to prepare, package, and distribute oxtail meat in a fully cooked and pulled form while maintaining its authenticity. The present disclosure solves this need.

### BRIEF SUMMARY OF THE INVENTION

In various aspects, a method of preparing pulled oxtail meat is provided and includes:
i) portioning raw oxtail into a plurality of sections, each section comprising oxtail bone and oxtail meat;
ii) seasoning the plurality of oxtail sections to provide seasoned oxtail portions;
iii) searing the seasoned oxtail portions to provide seared oxtail portions;
iv) slow-cooking the seared oxtail portions to provide cooked oxtail portions, wherein the internal temperature of the oxtail meat on at least one seared oxtail portion reaches a temperature of about 165° F.;
v) cooling the cooked oxtail portions from a temperature of about 130° F. to about 80° F. over a period of about 1 to 2 hours; and
vi) manually separating the oxtail meat from the oxtail bone to provide pulled oxtail meat and cooked oxtail bone.

Also provided are packaged oxtail meat products in which the oxtail is prepared by the methods described herein. Advantageously, in various aspects, by incorporating vacuum-sealing technology, the packaged oxtail meat and oxtail bone retains the meat's natural juiciness and extends shelf life, thereby making pulled oxtail suitable for commercial distribution while retaining its specific flavor profile and texture.

### BRIEF DESCRIPTION OF THE FIGURES

The drawings illustrate generally, by way of example, but not by way of limitation, various embodiments of the present application.

FIG. 1 lists the steps of preparing pulled oxtail meat, in accordance with various embodiments.

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

As used herein, a “food article” refers to any edible food that can include at least some amount of the pulled oxtail meat. Non-limiting examples of a food article include sandwiches, pastas, rice bowls, pizzas, sliders, wraps, stews, tacos, omelet, benedict, empanadas, egg rolls, and the like.

### Methods of Producing Pulled Oxtail Meat

In various embodiments, the process described herein provides a method tailored specifically to extracting the maximum amount of meat from oxtail with minimal waste. The complexity of removing meat from oxtail while preserving its texture and maximizing yield has likely deterred prior attempts at commercialization.

Traditionally, oxtail is slow-cooked and served bone-in because the meat adheres tightly to the bone, making it difficult to separate without compromising texture. No commercial method has successfully transformed oxtail into a pulled meat product while preserving its rich flavor and integrity. This disclosure provides a controlled cooking and hand-pulling process, allowing the meat to be fully separated from the bone without the use of mechanical shredding, which would compromise texture and quality.

Because oxtail has a high bone-to-meat ratio, traditional preparation methods leave meat on the bone, leading to waste and inefficiency. The methods described herein overcome that limitation by employing a specialized slow-cooking and hand-pulling technique that extracts the maximum amount of meat while keeping its natural texture intact. The result is a higher-yield product that offers more usable meat per oxtail portion, making it more cost-effective for both producers and end consumers.

Additionally, one of the key challenges in developing a pulled oxtail product is maintaining end consumer trust in its authenticity. Since oxtail has always been sold bone-in, removing the bone raises concerns about whether the meat is truly oxtail or a substitute like shredded beef. As described herein, such concerns are negated by including oxtail bone in each vacuum-sealed package as proof of authenticity and to contribute to the flavor of the oxtail meat, ensuring that end consumers such as direct purchasers, restaurants, food services, and the like receive genuine oxtail meat.

Oxtail is traditionally prepared fresh and served immediately, limiting its scalability in the packaged food market. In various embodiments, and as described herein, by incorporating vacuum-sealing technology, which locks in moisture, retains the meat's natural juiciness, and extends shelf life, the pulled oxtail becomes suitable for commercial distribution while retaining its specific flavor profile and texture.

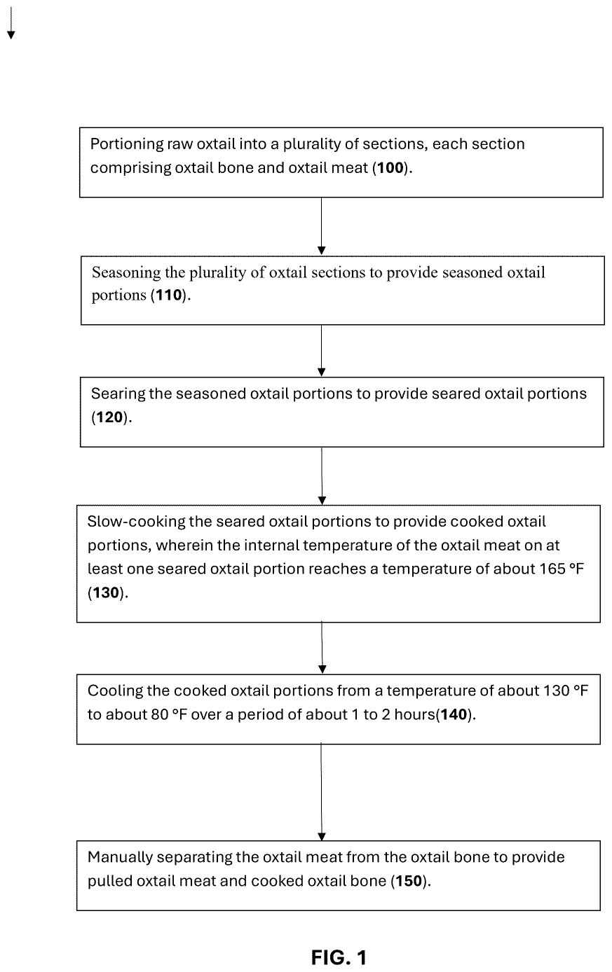

In various embodiments, a method of preparing pulled oxtail meat is provided. With reference to FIG. 1, the method includes:
i) portioning raw oxtail into a plurality of sections, each section comprising oxtail bone and oxtail meat (100);
ii) seasoning the plurality of oxtail sections to provide seasoned oxtail portions (110);
iii) searing the seasoned oxtail portions to provide seared oxtail portions (120);
iv) slow-cooking the seared oxtail portions to provide cooked oxtail portions, wherein the internal temperature of the oxtail meat on at least one seared oxtail portion reaches a temperature of about 165° F. (130);
v) cooling the cooked oxtail portions from a temperature of about 130° F. to about 80° F. over a period of about 1 to 2 hours (140); and
vi) manually separating the oxtail meat from the oxtail bone to provide pulled oxtail meat and cooked oxtail bone (150).

Portioning of the oxtail can be accomplished with a suitable cutting implement, such as a cleaver or bone saw. In various embodiments, the seasoning is any suitable seasoning that can be used with food products, including without limitation, salt, black pepper, garlic (fresh or powder), onion (fresh or powder), bay leaves, cumin, coriander, paprika (sweet, smoked, or hot), chili powder, cayenne pepper, allspice, cloves, cinnamon, nutmeg, star anise, cardamom, ginger (fresh or ground), thyme, rosemary, oregano, parsley, sage, marjoram, basil, cilantro, tarragon, dill, mustard (powder or prepared), horseradish, Worcestershire sauce, soy sauce, fish sauce, tomato paste, miso paste, Scotch bonnet or habanero peppers, pimento (allspice berries), scallions, curry powder, adobo seasoning, sazón, sofrito, annatto (achiote), smoked salt, celery seed, fennel seed, juniper berries, dried mushroom powder, beef bouillon or stock concentrate, red wine, beer, coffee (for depth), cocoa powder (in chili or mole-style preparations), fresh lemon or lime juice, vinegar (balsamic, red wine, or apple cider), fresh herbs, gremolata, and the like.

In various embodiments, the seasoning includes at least one of salt, pepper, and tomato paste.

In various embodiments, the searing can include contact with a hot metal surface, such as a pan, sheet, pot, or other cooking implement made from, for example, steel, cast iron, aluminum, ceramic, and the like. The searing is usually performed at a temperature of about 400-500° F., for example. Searing of the oxtail can include keeping each side of the oxtail in contact with the hot metal surface for about 5-9 minutes until the entire surface of the oxtail is seared. Searing can be done before or after the oxtail is seasoned. In various embodiments, the oxtail is seasoned before it is seared.

After the searing is complete, the seared oxtail, in various embodiments is slow-cooked until the internal temperature of the oxtail meat on at least one seared oxtail portion reaches a temperature of about 165° F. In various embodiments, the cooked oxtail meat and oxtail bone are free from any pathogens and is safe for human consumption.

In various embodiments, the period of cooling is about 1, 1.25, 1.5, 1.75, or about 2 hours. In various embodiments, the period of cooling is about 1.5 hours.

In various embodiments, the pulled oxtail meat is cooled from a temperature of about 80° F. to about 40° F. over a second period of about 30 minutes to about 1 hour. In various embodiments, the pulled oxtail meat is cooled over a period of about 0.5, 1, 1.5, 2, or 3 hours. In various embodiments, pulled oxtail meat is cooled over a period of about 3 hours.

In various embodiments, the method includes placing a segment of the cooked oxtail bone corresponding to the pulled oxtail meat into the packaging. Thus, the oxtail bone from which the oxtail meat is manually pulled (hand pulled) is placed into packaging. The oxtail bone can be a single oxtail bone segment. In various embodiments, the segment of cooked oxtail bone has a length of at least 3 inches. Alternatively, multiple oxtail bone segments can be present, all of which are the bone from which the oxtail meat was pulled from, where the total length of the multiple segments is at least 3 inches. Without being bound by theory, inclusion of the bone provides nutritional components such as collagen, such that when the packaged oxtail meat is warmed at home, the entire flavor profile of bone-in oxtail meat is recreated in the pulled oxtail meat.

Manually separating the meat includes using hands to pull the cooked meat off the bone, which ensures maximum yield of oxtail meat.

In various embodiments, the method also includes packaging the pulled oxtail meat. In various embodiments, the method includes vacuum sealing the packaging to provide vacuum-sealed packaging. In various embodiments, the vacuum-sealed packaging is configured for refrigeration at or below about 40° F. or freezing at or below about 0° F.

In various embodiments, the vacuum-sealed packaging further comprises labeling comprising a product name, safe handling instructions, and nutritional information. The labels are freezer-safe labels. In various embodiments, the packaging can optionally include oxygen absorbers to help maintain freshness. The packaging can include clear bags or opaque bags.

The packaging can be any suitable packaging for food products and is not particularly limited. For example, the packaging can include:
Embossed/textured vacuum bags containing a textured surface that allows for air extraction;
Smooth vacuum bags; or
Heavy-duty bags with a material thickness of 3-6 mil that are either smooth or embossed/textured.

In various embodiments, the packaging is BPA-free. In various embodiments, the packaging is freezer-grade material that slows or prevents freezer burn of the oxtail for long-term storage. In various embodiments, the packaging includes vacuum seal rolls made from any of the packaging materials described herein, which allows for custom sizing for different portions.

In various embodiments, the packaging can include:
Stand-up pouches with vacuum seal for retail-friendly presentation;
Zip-top vacuum bags which allow for resealing after opening; or
Bone guard bags.

In various embodiments, the packaging can include multi-layer laminated films, such as, without limitation, nylon/polyethylene combinations. The packaging can include an EVOH (ethylene vinyl alcohol) barrier layer as an oxygen barrier for extended shelf life. In various embodiments, the packaging made from FDA-approved and/or USDA-approved food-grade materials. In various embodiments, the packaging contains puncture-resistant materials that prevent the cooked oxtail bones from puncturing the packaging.

The packages can have any suitable size, depending on the amount of oxtail products that are packaged, for example, the packaging can be:
6″×10″ to 8″×12″ for individual portions (1-2 lbs) or
10″×13″ to 11″×16″ for family-size portions (3-5 lbs).

Other custom sizes of packages are also contemplated herein.

In various embodiments, a packaged oxtail meat product prepared by the methods described herein is provided. In various embodiments, a food article comprising pulled oxtail meat prepared by the method described herein is provided.

### Oxtail Meat Products

Traditional oxtail products are typically sold and served bone-in. Extracting oxtail meat presents challenges due to a uniquely high bone-to-meat ratio and tough connective tissues in the oxtail. In various embodiments, the oxtail meat products described herein incorporate a portion of the oxtail bone in the final packaging. This ensures end consumers recognize the product as genuine oxtail meat, distinguishing it from generic shredded or pulled beef. In various embodiments, the presence of the oxtail bone improves and/or maintains the flavor of the oxtail meat when prepared by the end consumer or restaurants and/or food services.

In various embodiments, a packaged oxtail meat product is provided. The packaged oxtail meat product includes:
sealed packaging that includes:
   manually pulled cooked oxtail meat; and
   cooked oxtail bone having a total length of at least 3 inches,
wherein the sealed packaging is configured for refrigeration at or below about 40° F. or freezing at or below about 0° F.

In various embodiments, the sealed packaging is vacuum sealed. In various embodiments, the oxtail in the sealed package contains at least one seasoning ingredient as described herein. In various embodiments, the seasoning ingredient is salt. In various embodiments, the manually pulled cooked oxtail meat in the sealed packaging was pulled off the cooked oxtail bone in the sealed packaging. In various embodiments, the sealed packaging further comprises labeling comprising a product name, safe handling instructions, and optionally nutritional information. The sealed packaging can be of any material and/or configuration described herein.

### EXAMPLES

Various embodiments of the present application can be better understood by reference to the following Examples which are offered by way of illustration. The scope of the present application is not limited to the Examples given herein.

The following steps were performed in a 5 gallon deep pot.

| Steps | Timing |
|---|---|
| Begin searing all seasoned pieces of oxtail for 7 min on | 20 min |
| each side (until dark brown). | |
| Remove oxtail pieces from pot and place them back on | |
| sheets trays. | |
| Empty oil and grit from pot. | |
| Apply tomato paste to cover all pieces on both sides. | 10 min |
| Add carrots, celery, onion, garlic in pot with no oil and | 5 min |
| sear for 5 min on med high. | |
| Add all oxtail pieces to the pot with veggies and garlic | |
| with residual seasoning and tomato paste. | |
| Add red wine and let cook for 10 min. | 10 min |
| Add remaining reserved seasonings to the pot, except | |
| pepper. Do not add leftover pepper. | |
| Add orange juice and 2 gallons of water to the pot | |
| Let pot come to boil and reduce heat to low and cover; | 6 hours |
| simmer for 6 hours checking at halfway point. | |

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

What is claimed is:

1. A method of preparing pulled oxtail meat, the method comprising:
i) portioning raw oxtail into a plurality of sections, each section comprising oxtail bone and oxtail meat;
ii) seasoning the plurality of oxtail sections to provide seasoned oxtail portions;
iii) searing the seasoned oxtail portions to provide seared oxtail portions;
iv) slow-cooking the seared oxtail portions to provide cooked oxtail portions, wherein the internal temperature of the oxtail meat on at least one seared oxtail portion reaches a temperature of about 165° F.;
v) cooling the cooked oxtail portions from a temperature of about 130° F. to about 80° F. over a period of about 1 to about 2 hours; and
vi) manually separating the oxtail meat from the oxtail bone to provide pulled oxtail meat and cooked oxtail bone.

2. The method of claim 1, further comprising cooling the pulled oxtail meat from a temperature of about 80° F. to about 40° F. over a period of about 0.5 to about 1 hour.

3. The method of claim 1, further comprising packaging the pulled oxtail meat.

4. The method of claim 3, further comprising placing a segment of the cooked oxtail bone corresponding to the pulled oxtail meat into the packaging.

5. The method of claim 4, wherein the segment of cooked oxtail bone has a length of at least 3 inches.

6. The method of claim 1, wherein the seasoning comprises at least one of salt, pepper, and tomato paste.

7. The method of claim 3, further comprising vacuum sealing the packaging to provide vacuum-sealed packaging.

8. The method of claim 7, wherein the vacuum-sealed packaging is configured for refrigeration at or below about 40° F. or freezing at or below about 0° F.

9. The method of claim 7, wherein the vacuum-sealed packaging further comprises labeling comprising a product name, safe handling instructions, and nutritional information.

10. A packaged oxtail meat product prepared by the method of claim 1.

11. A food article comprising pulled oxtail meat prepared by the method of claim 1.

12. The food article of claim 11, which is chosen from sandwiches, pastas, rice bowls, pizzas, sliders, wraps, stews, tacos, omelet, benedict, empanadas, or egg rolls.

13. A packaged oxtail meat product comprising:
sealed packaging comprising:
manually pulled cooked oxtail meat; and
cooked oxtail bone having a total length of at least 3 inches,
wherein the sealed packaging is configured for refrigeration at or below about 40° F. or freezing at or below about 0° F.

14. The packaged oxtail meat product of claim 13, wherein the sealed packaging is vacuum sealed.

15. The packaged oxtail meat product of claim 13, further comprising at least one seasoning ingredient.

16. The packaged oxtail meat product of claim 15, wherein the seasoning ingredient is salt.

17. The packaged oxtail meat product of claim 13, wherein the manually pulled cooked oxtail meat in the sealed packaging was pulled off the cooked oxtail bone in the sealed packaging.

18. The packaged oxtail meat product of claim 13, wherein the sealed packaging further comprises labeling comprising a product name, safe handling instructions, and optionally nutritional information.
